(19) United States
(12) Patent Application Publication
(10) Pub. No.: US 2013/0097298 A1
(43) Pub. Date: Apr. 18, 2013

(54) STANDARDIZED ADAPTER INTERFACE FOR MULTIPLE BROWSER-BASED DEVICES

(71) Applicant: OneScreen Inc., Irvine, CA (US)

(72) Inventors: Patrick Ting, Duarte, CA (US); Atul Patel, Irvine, CA (US); Jason Wong, Gardena, CA (US)

(73) Assignee: OneScreen Inc., Irvine, CA (US)

(21) Appl. No.: 13/650,531

(22) Filed: Oct. 12, 2012

Related U.S. Application Data
(60) Provisional application No. 61/548,323, filed on Oct. 18, 2011.

(51) Int. Cl. G06F 15/173

(52) U.S. Cl. 709/223

(57) ABSTRACT

An apparatus, a method, and a computer program are provided to determine a platform associated with a device attempting to access a webpage from a server. The determination of the browser is conducted upon initialization. Based on the platform associated with the device, a module within a library is loaded in order for commands from the device to be carried out accordingly.

### CROSS-REFERENCE TO RELATED APPLICATION

This application claims the benefit of U.S. Provisional Patent Application No. 61/548,323 filed on Oct. 18, 2011. The subject matter thereof is hereby incorporated herein by reference in its entirety.

### FIELD

The present invention relates to a standardized application programming interface and, more particularly, to a standardized application programming interface that facilitates control over a plurality of media devices that are capable of accessing the Internet through web-browsing software and other run-time environments.

### BACKGROUND

With the advent of “set-top box” devices, many programmers have to develop separate code for players that are compatible for each device, such as Google TV®, Sony® Internet TV device, Yahoo!® Connected TV Platform, Boxee®, etc. Programming webpages in order for media players to be compatible with each device can be time consuming, expensive, and inefficient.

### SUMMARY

Certain embodiments of the present invention may provide solutions to the problems and needs in the art that have not yet been fully identified, appreciated, or solved by current web-based applications. For example, one or more embodiments of the present invention pertain to a standardized application programming interface (API) that facilitates control over a plurality of media devices that are capable of accessing the Internet through web-browsing software and other run-time environments. The API can include an abstraction of defined actions or functionality (e.g., “Play”, “Stop”, “Fast Forward”, etc.) common to the plurality of media devices to allow the browsing of the Internet or media.

In one embodiment, an apparatus includes at least one processor and memory comprising instructions. The instructions, with the at least one processor, are configured to cause the apparatus to determine a platform associated with the apparatus when attempting to access a webpage from a server. The instructions, with the at least one processor, are further configured to cause the apparatus to receive a platform module from a database of a server based on the platform associated with the apparatus to carry out commands from the apparatus accordingly.

In another embodiment, an apparatus includes at least one processor and memory comprising instructions. The instructions, with the at least one processor, are configured to cause the apparatus to initialize an application programming interface. The application programming interface is configured to cause the apparatus to download a bootloader code to determine a platform of the apparatus.

In yet another embodiment, a computer-implemented method is provided. The computer-implemented method includes initializing, by a computing device, an application programming interface. The application programming interface is configured to cause the computing device to download a bootloader code to determine a platform of the computing device.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a system that can be implemented in accordance with an embodiment of the present invention.

FIG. 2 illustrates a system, in accordance with an embodiment of the present invention.

FIG. 3 illustrates a method for determining and loading a library, in accordance with an embodiment of the present invention.

### DETAILED DESCRIPTION OF THE EMBODIMENTS

It will be readily understood that the components of the invention, as generally described and illustrated in the figures herein, may be arranged and designed in a wide variety of different configurations. Thus, the following detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in, at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

Currently, several “set-top box” devices are being marketed to the consuming public. These devices are, in essence, web-browsing devices/platforms/run-time environments that use one of a plurality of APIs. The APIs allow the devices to access/browse the Internet or access media. However, the development of each API for each media device is not only time consuming, but also expensive and inefficient.

One or more embodiments described herein pertain to an API that includes an abstraction of defined actions or functionality (e.g., “Play”, “Stop”, “Fast Forward”, etc.) common to the plurality of media devices to allow the browsing of the Internet or media. The API can abstract the common behaviors between different APIs, such as simple up-down-left-right movement, playback, and pause, as well as any other functionality that would be appreciated by a person of ordinary skill in the art. As a result, the API allows control by a programmer/user of any single input across multiple different API platforms and devices. For example, the API may allow the up button on a remote control for Boxee® and Google TV® to have the same result, such as a pop-up menu.

Currently, there are no applications that would enable the intended unified control over multiple browser-based APIs for Internet browsing devices across the intended platforms. Many embodiments of the present invention allow for a greater simplification of the software development process when writing applications intended for use on multiple platforms, and allow division and improvement of development labor. For example, one or more embodiments described herein allow devoted developers to update a unified, abstract API, enabling other developers to implement functionality based on the unified API rather than per platform/device basis. Many embodiments of the present invention also facilitate a better user experience for the end-consumer in viewing/consuming Internet content, and allow for seamless functionality across multiple devices.

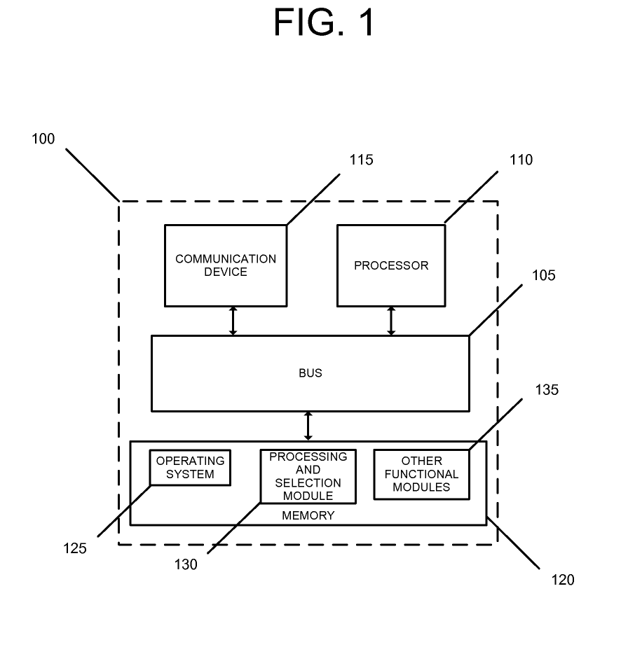

FIG. 1 illustrates a block diagram of a system 100 can be implemented in one or more embodiments of the present invention. System 100 may include a bus 105 or other communication mechanism that can communicate information and a processor 110, coupled to bus 105, that can process information. Processor 110 can be any type of general or specific purpose processor. System 100 may also include memory 120 that can store information and instructions to be executed by processor 110. Memory 120 can be comprised of any combination of random access memory (“RAM”), read only memory (“ROM”), static storage such as a magnetic or optical disk, or any other type of computer readable medium. System 100 may also include a communication device 115, such as a network interface card, that may provide access to a network.

The computer readable medium may be any available media that can be accessed by processor 110. The computer readable medium may include both volatile and nonvolatile medium, removable and non-removable media, and communication media. The communication media may include computer readable instructions, data structures, program modules, or other data and may include any information delivery media.

According to one embodiment, memory 120 may store software modules that may provide functionality when executed by processor 110. The modules can include an operating system 125 and a processing and selection module 130, as well as other functional modules 135. Operating system 125 may provide operating system functionality for system 100. Because system 100 may be part of a larger system, system 100 may include one or more additional functional modules 135 to include the additional functionality For example, functional modules 135 may include a module for Google TV®, a module for Sony® Internet TV devices, a module for Yahoo!® Connected TV Platforms, a module for Boxee® etc. These modules, when loaded by processing and selection module 130, may facilitate uniform functionality across multiple devices. In addition, these modules can be stored in a library and loaded when a webpage is accessed by the device or upon initialization of system 100.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations, which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

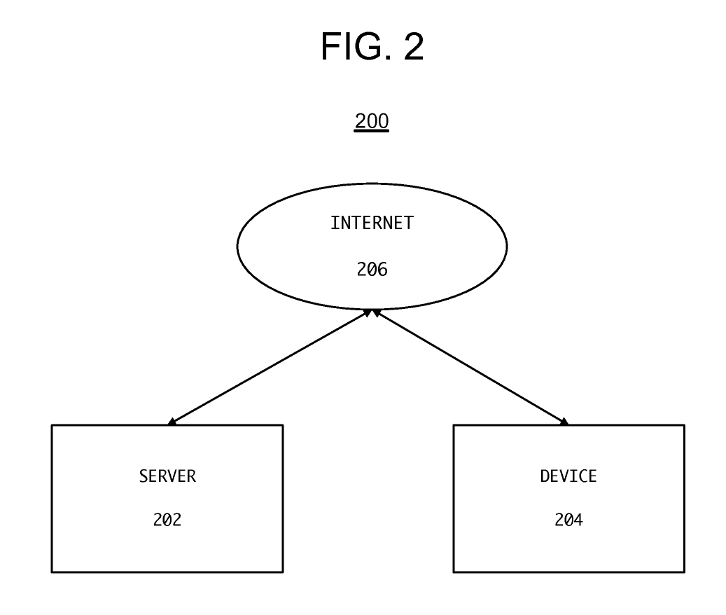

FIG. 2 illustrates a system 200, in accordance with an embodiment of the present invention. In this embodiment, system 200 includes a server 202 and a device 204 that are connected to Internet 206. Device 204 can be a Google TV® device, a Sony® Internet TV device, a Yahoo!® Connected TV Platform device, Boxee®, etc. However, one of ordinary skill in the art will recognize that embodiments of the present invention are not limited to these specific devices and other devices may be used. Server 202 can be a web server or any server that would be appreciated by a person of ordinary skill in the art. The server can be hardware, software, or a combination thereof that helps deliver content that can be accessed through the Internet.

In this embodiment, server 202 stores webpages in, for example, HTML5 format. Each webpage may include a JavaScript tool that facilitates an API. The API can be executed at run-time in a browser-based environment, and can cause server 202 to determine the platform of device 204 when device 204 is attempting to connect to the webpage. For example, if device 204 is a Google TV® device and is attempting to connect to a webpage hosted on server 202 then the API can cause server 202 to determine that the platform of the device attempting to connect to the webpage is a platform associated with a Google TV® device.

It should be appreciated that the platform of device 204 may be determined based on the characteristics of the platform and/or device 204. The characteristics of the platform and/or device 204 may be determined by verifying the existence of certain global variables within the platform and/or device 204, or, by performing comparisons of environment-identifying character strings, such as user agents, provided by the particular environment of platform and/or device 204. For example, server 202 can check the characteristics of device 204 as contained within a user agent string to determine the platform. Such characteristics can also include the device's operating system, the browser name, type, and version used by the device, and in some cases, an identification of the platform itself.

Stated another way, by initializing the API, the configuration of the API is such that a bootloader code is downloaded onto an application and/or device. The bootloader code is executed by the application and/or device and determines the type of platform and/or device 204. The process of determining the type of platform and/or device 204 can be carried out by looking for global variables, which correspond to a predetermined set of variables belonging to particular devices/platforms, or by performing a string comparison of the user-agent provided by the device and/or browser looking for names of a browser, version numbers, etc., in order to identify the actual browser and/or device.

This allows the API to cause server 202 to retrieve the appropriate module from a library for the platform associated with for example, the Google TV® device. As a result, when the user of the Google TV® device wishes to browse the Internet or carry out a function on a webpage, the appropriate functions can be carried out based on the module loaded by the API. For example, if the user wishes to view a menu and presses the appropriate menu button on a keyboard or keypad, then the API can cause server 202 to execute the appropriate function to load the menu based on the module that was loaded from the library.

It should be appreciated that the functionality can be the same across all platforms. For example, the up arrow or button on a Google TV® device, a Sony® Internet TV device, a Yahoo! ® Connected TV Platform device, Boxee®, etc., can have the same functionality, e.g., pop-up a menu. In another example, the down arrow or button on a Google TV® device, a Sony® Internet TV device, a Yahoo!® Connected TV Platform device, Boxee®, etc., can have the same functionality, e.g., hide the menu. In other words, regardless of whether the user is utilizing a keyboard, a remote control, or any input device, the API allows the functionality to be uniform across all platforms.

The API described herein can be an abstraction of multiple APIs by taking “individualized” functionality across multiple APIs or taking an abstraction of commonly used APIs that developers can adapt towards a common language for multiple APIs. The API can be located on a physical device or as often used by software developers, a “mock device” that logs input actions and creates output actions accordingly, and later implementing this functionality into a physical device.

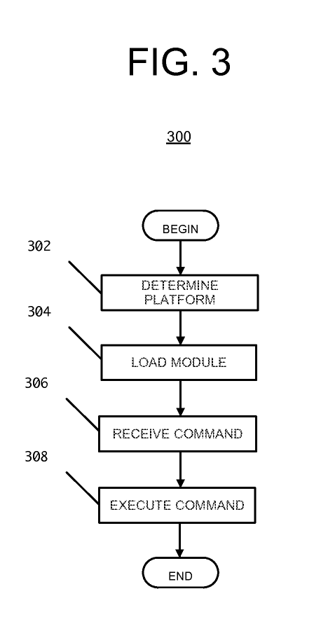

FIG. 3 illustrates a method 300 for determining and loading a library, in accordance with an embodiment of the present invention. The process can be executed by, for example, the systems shown in FIGS. 1 and/or 2.

At 302, upon initialization of the API module, the API module is configured to determine the platform of the device accessing the webpage. For instance, the API module determines whether the webpage is accessed by a Google TV® based platform, a Sony® Internet TV device based platform, a Boxee® based platform, etc. Upon determination of the platform, the API is configured to load the appropriate module for the platform accessing the webpage at 304. For example, if the platform is for Google TV®, then the API loads the module for the Google TV® based platform. It should be appreciated that the module being loaded may be from a library associated to the platform being called. In other words, each module is platform specific and is stored in a library in some embodiments.

It should also be appreciated that the modules for each platform can be programmed as the developer desires. In some embodiments, the developer can develop or create modules for each platform (or “set-top device”) so the functions can be uniform across each platform. For example, if the developer desires that the down button, or any input button, closes media or a webpage, then each module can be specifically tailored to execute such functions.

At 306, a command is received to execute a function. In the case where a user or developer is watching or accessing media using a Boxee® device and the user wants to see the menu screen, the user may select the up arrow on the remote or input device. Once the button is pressed on the remote or input device, the command is received by the system to execute the function of displaying the menu. Similarly, in the case where the user is watching media using a Google TV® device and the user wants to see the menu, the user may select, the up arrow on the keyboard or input device. Once the button is pressed on the keyboard or input device, the command is received by the system to execute the function of displaying. At 308, based on the command request, the API is configured to execute the function being requested.

The method shown in FIG. 3 can be performed, in part, by a computer program, encoding instructions for a nonlinear adaptive processor to cause at least the method described in FIG. 3 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data The computer program may include encoded instructions for controlling the nonlinear adaptive processor to implement the method described in FIG. 3, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. An apparatus, comprising:
at least one processor; and
memory comprising instructions, wherein
the instructions, with the at least one processor, is configured to cause the apparatus to:
determine a platform associated with the apparatus when attempting to access a webpage from a server, and
receive a platform module from a database of a server based on the platform associated with the apparatus to carry out commands from the apparatus accordingly.

2. The apparatus of claim 1, wherein the instructions, with the at least one processor, are further configured to cause the apparatus to determine the platform associated with the apparatus upon initialization of an application programming interface module.

3. The apparatus of claim 2, wherein the application programming interface module, with the at least one processor, is further configured to cause the apparatus to determine the platform associated with the apparatus based on characteristics of the platform, the apparatus, or both.

4. The apparatus of claim 3, wherein the application programming interface module, with the at least one processor, is further configured to cause the apparatus to determine the platform associated with the apparatus by verifying existence of global variables within the platform, the apparatus, or both.

5. The apparatus of claim 3, wherein the application programming interface module, with the at least one processor, is, further configured to cause the apparatus to determine the platform associated with the apparatus based on a comparison of environment-identifying character strings of the platform, the apparatus, or both.

6. The apparatus of claim 1, wherein the loaded platform module is configured to perform uniform functions across a plurality of platforms associated with the apparatus.

7. The apparatus of claim 1, wherein the instructions, with the at least one processor, are further configured to cause the apparatus to receive a command from a remote device after the platform module is loaded.

8. The apparatus of claim 7, wherein the instructions, with the at least one processor, are further configured to cause the apparatus to execute the function of the requested command using the loaded platform module.

9. The apparatus of claim 2, wherein the application programming interface module, with the at least one processor, is executed at run-time in a browser-based environment to cause the apparatus to determine the platform of the device attempting to access or connect to the webpage.

10. An apparatus, comprising:
at least one processor; and
memory comprising instructions, wherein
the instructions, with the at least one processor, are configured to cause the apparatus to initialize an application programming interface, the application programming interface configured to cause the apparatus to download a bootloader code to determine a platform of the apparatus.

11. The apparatus of claim 10, wherein the bootloader code is downloaded from a server.

12. The apparatus of claim 10, wherein the bootloader code, with the at least one processor, is configured to cause the apparatus to determine the platform based on global variables of the platform.

13. The apparatus of claim 10, wherein the bootloader code, with the at least one processor, is further configured to cause the apparatus to determine the platform based on a comparison of environment-identifying character strings.

14. The apparatus of claim 10, wherein the application programming interface, with the at least one processor, is configured to cause the apparatus to transmit a message identifying the determined platform to a server comprising a plurality of modules for a plurality of platforms.

15. The apparatus of claim 14, wherein the application programming interface, with the at least one processor, is further configured to cause the apparatus to receive a platform module for the determined platform associated with the apparatus from the server.

16. The apparatus of claim 15, wherein the application program interface, with the at least one processor, is further configured to cause the apparatus to load the platform module to allow a remote device connected to the apparatus to control various functions on the apparatus.

17. A computer-implemented method, comprising:
initializing, by a computing device, an application programming to download a bootloader code; and
downloading, by the computing device, the bootloader code from a server to determine a platform of the computing device.

18. The computer-implemented method of claim 17, wherein the determining of the platform is based on global variables of the platform.

19. The computer-implemented method of claim 17, wherein the determining of the platform is based on a comparison of environment-identifying character strings.

20. The computer-implemented method of claim 17, further comprising:
transmitting, by the computing device, a message identifying the determined platform to a server comprising a plurality of modules for a plurality of platforms.

21. The computer-implemented method of claim 20, further comprising:
receiving a platform module for the determined platform associated with the computing device from the server.

22. The computer-implemented method of claim 21, further comprising:
loading, by the computing device, the platform module to allow a remote device connected to the computing device to control various functions on the computing device.
